(19) United States
(12) Patent Application Publication
(10) Pub. No.: US 2025/0012138 A1
(43) Pub. Date: Jan. 9, 2025

(54) Window Systems and their Manufacturing Methods

(71) Applicant: VIG GASKET COMPANY, LLC, Jupiter, FL (US)

(72) Inventors: Charles E. Boyer, Elysian, MN (US); Arthur R. Huard, Toronto (CA); Michael F. Spellman, North Palm Beach, FL (US)

(73) Assignee: VIG GASKET COMPANY, LLC, Jupiter, FL (US)

(21) Appl. No.: 18/897,177

(22) Filed: Sep. 26, 2024

Related U.S. Application Data
(63) Continuation of application No. PCT/US2023/016715, filed on Mar. 29, 2023.
(60) Provisional application No. 63/325,346, filed on Mar. 30, 2022.

(51) Int. Cl. E06B 3/66; E06B 3/58; E06B 3/663; E06B 3/673

(52) U.S. Cl. CPC E06B 3/6621; E06B 3/5878; E06B 3/6612; E06B 3/66304; E06B 3/67326; E06B 3/66333; E06B 3/66352

(57) ABSTRACT

Vacuum insulating glass units, vacuum insulating glass unit assemblies, and methods for making and using the same are disclosed. An example vacuum insulating glass unit may include a generally planar first lite of glass and a generally planar second lite of glass, each having a perimeter surface. At least one pillar array may be arranged between the first lite of glass and the second lite of glass. A metallic sealing component, or a ceramic frit sealing component, may be provided around a perimeter of the first lite of glass and the second lite of glass. A gasket may be provided adjacent to the perimeter surface of the first lite of glass and the perimeter surface of the second lite of glass. The vacuum insulating glass unit assembly with the gasket may be configured to be installed within a window frame.

### CROSS-REFERENCE TO RELATED APPLICATIONS

This application is a continuation of International Application No. PCT/US2023/016715, filed Mar. 29, 2023, which claims priority to U.S. Provisional Application Ser. No. 63/325,346, filed Mar. 30, 2022, the entirety of which are incorporated herein by reference.

### TECHNICAL FIELD

The present disclosure relates generally to window systems. The present disclosure relates more particularly to improved window systems and their manufacturing methods, including improved vacuum insulating glass units.

### BACKGROUND

A wide variety of window systems have been developed. Such window systems may be manufactured by any one of a variety of different manufacturing methods and may be used according to any one of a variety of methods. Of the known window systems and methods, each has certain advantages and disadvantages. There is an ongoing need to provide alternative or improved window systems as well as alternative or improved methods for manufacturing and using window systems.

### BRIEF SUMMARY

This disclosure provides design, material, manufacturing method, and use alternatives or improvements for window systems. An improved window system is disclosed. The improved window system comprises: a window frame; a vacuum insulating glass unit assembly including: a generally planar first lite of glass and a generally planar second lite of glass, each having a perimeter surface; at least one pillar array arranged between the first lite of glass and the second lite of glass, for provision of generally uniform spacing between the first lite of glass and the second lite of glass; and a metallic sealing component or a ceramic frit sealing component, provided around a perimeter of the first lite of glass and the second lite of glass, to enable a vacuum to be provided between the first lite of glass and the second lite of glass when a gas is evacuated from the spacing between the first lite of glass and the second lite of glass; and a gasket provided adjacent to the perimeter surface of the first lite of glass and the perimeter surface of the second lite of glass, the gasket component being generally positioned uniformly about the perimeter surface of the first lite of glass and the perimeter surface of the second lite of glass, wherein the vacuum insulating glass unit assembly with the gasket are configured to be installed in the window frame.

Alternatively or additionally to any of the embodiments above, the first lite of glass and the second lite of glass each have a thickness in a range of 3.0 millimeters to 10.0 millimeters.

Alternatively or additionally to any of the embodiments above, the spacing between the first lite of glass and the second lite of glass is in a range of 0.20 millimeters to 0.50 millimeters.

Alternatively or additionally to any of the embodiments above, at least one of the first lite of glass and the second lite of glass is tempered or annealed.

Alternatively or additionally to any of the embodiments above, the at least one pillar array comprises a steel construction.

Alternatively or additionally to any of the embodiments above, the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

Alternatively or additionally to any of the embodiments above, the gasket is generally constructed of at least one material selected from a group comprising: rubber; silicone; ethylene propylene diene monomer; ethylene propylene diene terpolymer; neoprene; and chloroprene.

A method of manufacturing an improved window system is disclosed. The method comprises: providing a window frame; providing a vacuum insulating glass unit assembly including: a generally planar first lite of glass and a generally planar second lite of glass, each having a perimeter surface; at least one pillar array arranged between the first lite of glass and the second lite of glass, for provision of generally uniform spacing between the first lite of glass and the second lite of glass; a metallic sealing component or a ceramic frit sealing component, provided around a perimeter of the first lite of glass and the second lite of glass; providing a vacuum between the first lite of glass and the second lite of glass by evacuating a gas from the spacing between the first lite of glass and the second lite of glass; providing a gasket adjacent to the perimeter surface of the first lite of glass and the perimeter surface of the second lite of glass, the gasket component being generally positioned uniformly about the perimeter surface of the first lite of glass and the perimeter surface of the second lite of glass; and installing the vacuum insulating glass unit assembly with the gasket in the window frame.

Alternatively or additionally to any of the embodiments above, the first lite of glass and the second lite of glass each have a thickness in a range of 3.0 millimeters to 10.0 millimeters.

Alternatively or additionally to any of the embodiments above, the spacing between the first lite of glass and the second lite of glass is in a range of 0.20 millimeters to 0.50 millimeters.

Alternatively or additionally to any of the embodiments above, at least one of the first lite of glass and the second lite of glass is tempered or annealed.

Alternatively or additionally to any of the embodiments above, the at least one pillar array comprises a steel construction.

Alternatively or additionally to any of the embodiments above, the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

Alternatively or additionally to any of the embodiments above, the gasket is generally constructed of at least one material selected from a group comprising: rubber; silicone; ethylene propylene diene monomer; ethylene propylene diene terpolymer; neoprene; and chloroprene.

A gasket for an improved window system is disclosed. The gasket comprises: a gasket material that is configured to be generally provided adjacent to a perimeter surface of a first lite of glass and a perimeter surface of a second lite of glass, the gasket component being generally positioned uniformly about the perimeter surface of the first lite of glass and the perimeter surface of the second lite of glass, wherein the gasket improves thermal properties of the window system.

Alternatively or additionally to any of the embodiments above, the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

Alternatively or additionally to any of the embodiments above, the gasket is generally constructed of at least one material selected from a group comprising: rubber; silicone; ethylene propylene diene monomer; ethylene propylene diene terpolymer; neoprene; and chloroprene.

A method of manufacturing a gasket for an improved window system is disclosed. The method comprises: providing a gasket material that is configured to be generally provided adjacent to a perimeter surface of a first lite of glass and a perimeter surface of a second lite of glass, the gasket component being configured to be generally positioned uniformly about the perimeter surface of the first lite of glass and the perimeter surface of the second lite of glass, wherein the gasket improves thermal properties of the window system.

Alternatively or additionally to any of the embodiments above, the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

Alternatively or additionally to any of the embodiments above, the gasket is generally constructed of at least one material selected from a group comprising: rubber; silicone; ethylene propylene diene monomer; ethylene propylene diene terpolymer; neoprene; and chloroprene.

A vacuum insulating glass unit assembly is disclosed. The vacuum insulating glass unit assembly comprises: a generally planar first lite of glass and a generally planar second lite of glass, each having a perimeter surface; at least one pillar array arranged between the first lite of glass and the second lite of glass, for provision of generally uniform spacing between the first lite of glass and the second lite of glass; and a metallic sealing component or a ceramic frit sealing component, provided around a perimeter of the first lite of glass and the second lite of glass, to enable a vacuum to be provided between the first lite of glass and the second lite of glass when a gas is evacuated from the spacing between the first lite of glass and the second lite of glass; and a gasket provided adjacent to the perimeter surface of the first lite of glass and the perimeter surface of the second lite of glass, wherein the vacuum insulating glass unit assembly with the gasket are configured to be installed within a window frame.

Alternatively or additionally to any of the embodiments above, the first lite of glass and the second lite of glass each have a thickness in a range of 3.0 millimeters to 10.0 millimeters.

Alternatively or additionally to any of the embodiments above, the spacing between the first lite of glass and the second lite of glass is in a range of 0.20 millimeters to 0.50 millimeters.

Alternatively or additionally to any of the embodiments above, at least one of the first lite of glass and the second lite of glass is tempered or annealed.

Alternatively or additionally to any of the embodiments above, the at least one pillar array comprises a steel construction.

Alternatively or additionally to any of the embodiments above, the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

Alternatively or additionally to any of the embodiments above, the gasket is generally constructed of at least one material selected from a group comprising: rubber; silicone; ethylene propylene diene monomer; ethylene propylene diene terpolymer; neoprene; and chloroprene.

Alternatively or additionally to any of the embodiments above, the gasket component is generally positioned uniformly about the perimeter surface of the first lite of glass and the perimeter surface of the second lite of glass.

Alternatively or additionally to any of the embodiments above, further comprising the window frame.

A vacuum insulating glass unit assembly is disclosed. The vacuum insulating glass unit assembly comprises: a window frame; a vacuum insulating glass unit coupled to the window frame, the vacuum insulating glass unit having a perimeter; a gasket disposed about the perimeter of the vacuum insulating glass unit, the gasket having a plurality of projections and a channel formed therein that is configured to receive the vacuum insulating glass unit.

A vacuum insulating glass unit assembly is disclosed. The vacuum insulating glass unit assembly comprises: a window frame; a vacuum insulating glass unit coupled to the window frame, the vacuum insulating glass unit having a perimeter; a gasket disposed about the perimeter of the vacuum insulating glass unit, the gasket having a plurality of fins and a channel formed therein that is configured to receive the vacuum insulating glass unit.

A vacuum insulating glass unit assembly is disclosed. The vacuum insulating glass unit assembly comprises: a vacuum insulating glass unit configured to be coupled to a window frame, the vacuum insulating glass unit having a perimeter; a gasket disposed about the perimeter of the vacuum insulating glass unit, the gasket having a plurality of projections and a channel formed therein that is configured to receive the vacuum insulating glass unit.

A vacuum insulating glass unit assembly is disclosed. The vacuum insulating glass unit comprises: a vacuum insulating glass unit configured to be coupled to a window frame, the vacuum insulating glass unit having a perimeter; a gasket disposed about the perimeter of the vacuum insulating glass unit, the gasket having a plurality of fins and a channel formed therein that is configured to receive the vacuum insulating glass unit.

A vacuum insulating glass unit assembly is disclosed. The vacuum insulating glass unit assembly comprises: one or more lites of glass defining a perimeter surface; a metallic sealing component or a ceramic frit sealing component, provided around the perimeter surface; and a gasket disposed adjacent to the perimeter surface, wherein the vacuum insulating glass unit assembly with the gasket are configured to be installed within a window frame.

A gasket for use with a vacuum insulating glass unit is disclosed. The gasket comprises: a gasket body having a channel formed therein, the channel being configured to receive a vacuum insulating glass unit, wherein a plurality of projections are disposed along the gasket body.

A method of manufacturing an improved window system is disclosed. The method comprises: disposing a gasket about a perimeter of a vacuum insulating glass unit assembly, the vacuum insulating glass unit assembly comprising: a generally planar first lite of glass and a generally planar second lite of glass, each having a perimeter surface; at least one pillar array arranged between the first lite of glass and the second lite of glass, for provision of generally uniform spacing between the first lite of glass and the second lite of glass; a metallic sealing component or a ceramic frit sealing component, provided around a perimeter of the first lite of glass and the second lite of glass; and providing a vacuum between the first lite of glass and the second lite of glass by evacuating a gas from the spacing between the first lite of glass and the second lite of glass; installing the vacuum insulating glass unit assembly with the gasket in a window frame.

The above summary of some embodiments is not intended to describe each disclosed embodiment or every implementation of the present disclosure. The Figures, and Detailed Description, which follow, more particularly exemplify such embodiments.

### BRIEF DESCRIPTION OF THE DRAWINGS

The disclosure may be more completely understood in consideration of the following detailed description in connection with the accompanying drawings, in which:

FIG. 1 is a cross-sectional view illustrating an example of a conventional IGU.

FIG. 1A is a cross-sectional view illustrating an example of the conventional IGU of FIG. 1 in an example of a window unit.

FIG. 2 is a cross-sectional view illustrating an example of a vacuum insulating glass (“VIG”) unit.

FIG. 3 is a cross-sectional illustration of an example of an improved VIG unit system in accordance with an embodiment of the disclosure.

FIG. 4 is a magnified cross-sectional illustration of an example of a gasket in the improved VIG unit system of FIG. 3, in accordance with an embodiment of the disclosure.

FIG. 5 is a flowchart of an example of a method of manufacturing an improved VIG window system unit.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values herein should be understood to be modified by the term “about”, whether or not explicitly indicated, unless specified otherwise. The term “about” generally refers to a range of numbers that one of skill in the art would consider equivalent or nearly so to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5) unless specified otherwise.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are usually numbered similarly. The drawings, which are not necessarily to scale, depict illustrative embodiments and are not intended to limit the scope of the disclosure.

Conventional window systems for residential and commercial buildings have been, in recent times, typically constructed of wood, vinyl, or metal that frame and support insulating glass units or “IGUs.” IGUs may be commercially available from, for example, Cardinal Glass Industries, Inc. and Viracon/Apogee Enterprises, Inc., and a host of other IGU fabricators worldwide. An IGU often utilizes “lites” of glass that are hermetically scaled to a metal or polymer perforated tube using a polyisobutylene material or “PIB”, and a silicone secondary structural sealant. PIB may be commercially available from, for example, H.B. Fuller Company/Kömmerling and ADCO Products Inc.; and silicone may be commercially available from, for example, The Dow Chemical Company, Momentive Performance Materials Inc., and H.B. Fuller Company/Kömmerling. The perforated tube is commonly called a “spacer” in the industry. Spacers may be commercially available from, for example, Helima GmbH, Ramapo Sales and Marketing, Inc., and CERA GmbH. Upon forming the spacer into an acceptable orientation, dimension, or geometry to correspond to a perimeter of the lites of glass, desiccant is typically introduced within a hollow portion of the spacer and then ends of the spacer are joined together with what are commonly called “connector keys” in the industry. Spacers are typically available in a variety of designs and as such there typically are a variety of connector key designs to mate with the spacers. Connector keys may be commercially available from, for example, Eduard Kronenberg GmbH.

Conventional IGUs became popular for window systems in the 1970s, and the addition of low emissivity coatings to one or more lites of glass in IGUs began to be used in the 1980s. Essentially there has been little change to overall design and performance of IGUs since the 1980s. It is to be noted, however, that many buildings in North America still have very basic single pane windows that may be 40 to 50 years old. A single pane window typically has an insulating (in some publications, “thermal resistance”) or “R” value of one (R=1) while a solid wall (non-glass) can have R=10 or more. But with implementation of conventional IGUs as aforementioned, as alternatives to basic single pane windows, insulating values typically increased from R=1 to R=3. With introduction of so-called “triple IGUs” in northern climates where better insulating values were desired, IGUs became heavier and more complex in their constructions. Triple IGUs commonly include three lites of glass that are separated by gaps containing air or argon gas to improve thermal resistance. A triple IGU may improve insulating value to R=5 versus a conventional IGU of R=3.

In addition to desires for even better insulating values for windows, there has also developed a pronounced interest in reducing carbon emissions to the atmosphere (also known globally as “reducing the carbon foot print”). It has been well documented that a window can be primarily responsible for overall energy loss from a building, with a single pane window being the worst performer. As such, window units have been identified as being major contributors to harmful carbon emissions and the carbon foot print.

In response to the aforementioned desires for better insulating values and reducing the carbon foot print, vacuum insulating glass (“VIG”) units for windows have been developed and have become recognized as a further advancement in the industry for energy efficiencies beyond the benefits of previous IGUs. Essentially, as will be further described, a VIG unit utilizes a vacuum between lites of glass to provide significantly improved R values compared to IGUs and window units of older and more primitive constructions. In recent years there have been a relatively small number of companies that have successfully brought VIG technology to the market. Among these are the VacuMax™ VIG technology of Vitro Architectural Glass, the LandVac tVIG™ technology of Luoyang Landglass Technologies Co., Ltd., and the Pilkington Spacia™ technology of Pilkington North America, part of the Nippon Sheet Glass Group. For example, a window unit utilizing tVIG™ technology typically has an insulating value of about R=15.4, while being only about 8.4 mm in total thickness. These attributes make the tVIG™ technology an ideal candidate to directly replace single pane windows that often have total thicknesses ranging from 6 mm to 10 mm.

When measuring or determining an “R” value, as aforementioned, of a window system, three factors are commonly considered. A window system's R value may be mathematically expressed as: System R=(Center of Glass R+Edge of Glass R+Frame R). It is important to note that the System R equation is useful for conventional IGU window systems because R values along a perimeter or edge will be considerably lower than at the center. Commonly in a conventional IGU window system, about two and a half inches of a perimeter of the window is included in the Edge of Glass R. This is because conventional IGUs are typically about one inch wide, with two lites of ¼ inch glass separated by about a ½ inch air or argon gas space. The air or argon within the space is subject to convection and, as such, the R value diminishes with distance from the center of the IGU. It is to be also noted that for a conventional IGU, orientation affects R values due to convection. As the installation of an IGU changes from a vertical to a horizontal orientation, the R value decreases due to convection phenomenon.

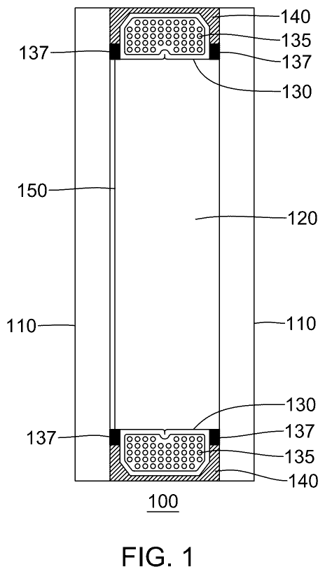

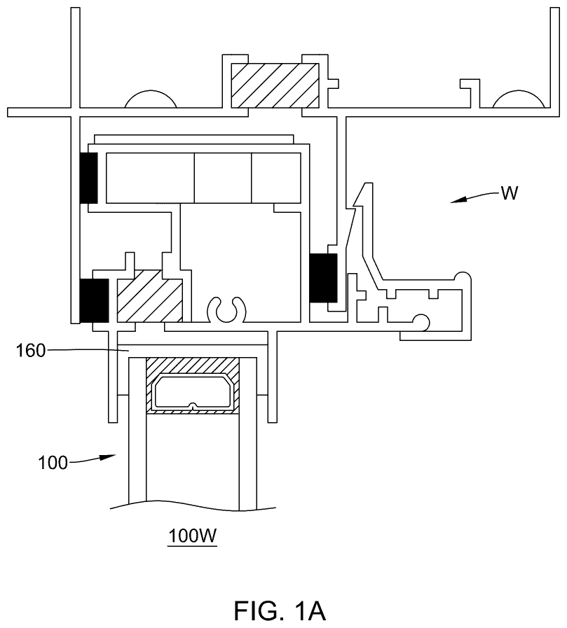

With the foregoing background and description in mind, FIGS. 1 and 1A are cross-sectional or side views illustrating, respectively, examples of a conventional IGU 100 and an IGU window unit 100W. Throughout the various drawings associated with this document including FIGS. 1 and 1A, among others, it is to be understood that depictions of components may not be to scale and/or may be shown in individual scaling that is inconsistent with other components. As such, the drawings may be magnified or exaggerated in appearance, to aid in understanding various components and concepts described herein. In FIG. 1, an example of an IGU 100 includes lites of glass 110 separated by air or an air space 120. Spacers 130 containing a suitable desiccant 135 are provided, with seals 140 and typically, as aforementioned, PIB 137, to seal the lites of glass 110. Seals 140 are typically a suitable silicone material. A low-e coating 150 is commonly provided on a lite of glass 110.

With reference also now to FIG. 1A, conventional IGU 100 is partially shown in an example of a portion of a frame of a window W in a window unit 100W. As depicted, a securing component 160 functions to secure IGU 100 in window unit 100W. Securing component 160 may be constructed from, for example, a suitable rubber or rubber-like material.

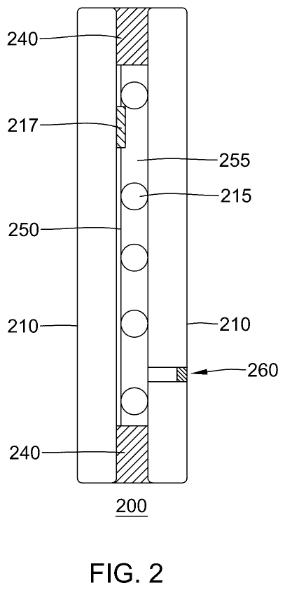

In FIG. 2, an example of a VIG unit 200 includes lites of glass 210. A low-e coating 250 is commonly provided on a lite of glass 210. Lites of glass 210 are separated by at least one micro support pillar array comprising pillars 215 within a vacuum gap or vacuum chamber 255. A vacuum/gas evacuation port 260 provides access to vacuum chamber 255, for evacuation of air and/or gas therefrom. It is to be appreciated and understood that an evacuation port, that may also be referred to as a “pump-out port”, typically includes a channel between the port and the vacuum gap or chamber from which the air and/or gas was evacuated. The channel can be hermetically sealed with a corrosion-resistant metal cap. In an embodiment, the evacuation port can be supplemented by a port sealant to improve durability. In an embodiment, the evacuation port can be sufficiently closed or sealed with a glass plug in combination with, for example, a UV cured polymer and/or a metal cap.

Typically also in a VIG unit such as the example of VIG unit 200, a getter 217 is provided adjacent to an internal surface of a lite of glass 210 in vacuum chamber 255. In an embodiment, a getter can comprise one or more disks or pellets that may be referred to as “bulk getter” and countersunk into corners of uncoated lites of glass within the vacuum gap or vacuum chamber. A getter can, for example, comprise Ba, V, Ni, Fe, and/or Ti. Typically, such getter material becomes heat-activated during manufacture of a VIG unit, and functions to maintain the vacuum the vacuum gap or chamber by “scavenging” undesired particles and other unwanted material that may be present therewithin. In an embodiment, a getter may comprise a so-called non-evaporable getter or “NEG”.

With continued reference to FIG. 2, pillars 215 are arranged between lites of glass 210 to provide generally uniform spacing between them. Generally, pillars may also be referred to as “micro support pillars” or “supports”. It is to be appreciated and understood that pillar arrays, of pillars 215, function to inhibit lites of glass 210 from flexing inwardly or toward each other when air and/or gas in the space between them, primarily in vacuum chamber 255, is evacuated at port 260 to create the desired insulating vacuum between lites of glass 210. In an embodiment, individual pillars in a pillar array can comprise stainless steel and be of a generally oval or rounded cylinder shape, with relatively flat bases thereof configured for physical contact with the lites of glass. Each pillar can be, for example, in a size range of 0.20 millimeters to 0.50 millimeters. Aside from those illustrated by example in FIG. 2, it is also to be appreciated and understood that pillar arrays can be provided in various configurations and distributions in various VIG units. For example, in an embodiment of a VIG unit, pillar arrays between lites of glass can be in a generally symmetric distribution of about 55 millimeters by 55 millimeters or closer. Typically, distributions of pillar arrays between lites of glass are determined with respect to relative strength or weakness of the glass when a vacuum is created in the vacuum chamber between the lites of glass. Pillar arrays could also be provided in asymmetric distributions such as, for example, 55 millimeters by 60 millimeters. However, such asymmetric distributions of pillar arrays could result in difficulties if units are created on an assembly line in both horizontal and vertical orientations. Hence, a symmetric distribution (such as, for example, the aforementioned 55 millimeters by 55 millimeters) allows for relatively equal efficiencies in manufacturing with, e.g., horizontal or vertical orientations on an assembly line.

With continued reference to FIG. 2, the example of a VIG unit also includes a metal seal 240 between lites of glass 210. As shown in FIG. 2, metal seal 240 can be set back from, or not extend to, outer edges of lites of glass 210. Each metal seal 240 can serve as a primary seal to maintain the vacuum between lites of glass 210 when air and/or gas is evacuated or pumped out of vacuum chamber 255 at port 260. In an embodiment, the set-back of metal seal 240 from outer edges of lites of glass 210 is about 1.5 millimeters. In an embodiment, secondary seals (not illustrated) can also be provided between each metal seal 240 and outer edges of lites of glass 210. It is to be appreciated and understood that the aforementioned metal seals, that may also be referred to as “primary edge seals”, can in an embodiment be a metal solder comprising metallic and intermetallic elements and compounds. The metal seals, or primary edge seals, can, for example, be an alloy of one or more of Sn, Ag, Cu, Zn, Bi, In, and Ti; and they are typically expected to be corrosion-resistant. It is also to be appreciated and understood that the aforementioned secondary seals can, in an embodiment, be an acrylate or an organic polymeric material that covers the metal seals or primary edge seals, to provide barriers against ingress of water vapor, moisture, and other components and chemistries that may be deleterious to the VIG unit.

Typically a VIG unit—such as, for example, VIG unit 200—has minimal to no convection within the unit. Therefore, the R value can remain relatively uniform from the center to the edge of the unit. In the aforementioned tVIG™ units, the edge can be hermetically sealed by a metal solder or metal material to provide a metal seal having a width of about 7.5 millimeters and a thickness of about 0.4 millimeters. Generally, around perimeters of VIG units where metal seals reside, localized R values will be decreased compared to other locations around the units. This decrease in R value can be mitigated by way of an improved VIG unit system as will now be described.

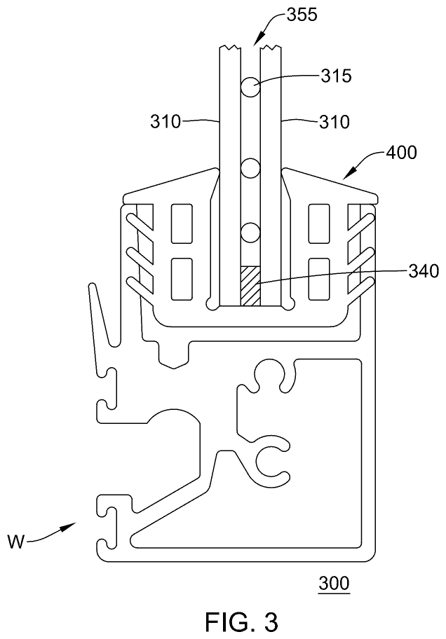

Referring now to FIG. 3, therein illustrated is an example of an improved VIG unit system 300 in accordance with an embodiment of the disclosure, for a frame of a window W. In FIG. 3, an embodiment of an improved VIG unit system 300 includes lites of glass 310. A low-e coating (not illustrated) is commonly provided on a lite of glass 310. In an embodiment, lites of glass 310 and the low-e coating can be similar to lites of glass 210 and low-e coating 250 as aforedescribed. Lites of glass 310 are separated by at least one micro support pillar array comprising pillars 315 within a vacuum gap or vacuum chamber 355. In an embodiment, the at least one pillar array, pillars 315, and vacuum gap or vacuum chamber 355 can be similar to the at least one pillar array, pillars 215, and vacuum gap or vacuum chamber 255 as aforedescribed. A vacuum/gas evacuation port (not illustrated) provides access to vacuum chamber 355, for evacuation of air and/or gas therefrom as aforedescribed. A getter (also not illustrated) can be provided adjacent to an internal surface of a lite of glass 310 in vacuum chamber 355. In an embodiment, the evacuation port and getter can be similar to evacuation port 260 and getter 217 as aforedescribed.

With continued reference to FIG. 3, the example of an improved VIG unit system 300 also includes a metal seal 340 between lites of glass 310. In an embodiment, metal seal 340 can be similar to metal seal 240, as aforedescribed, and set back from, or not extend to, outer edges of lites of glass 310. In an embodiment, secondary seals as aforedescribed can also be provided between each metal seal 340 and outer edges of lites of glass 310.

Similarly to the example of a VIG unit in FIG. 2, the example of an improved VIG unit system 300 can advantageously have minimal to no convection therewithin, and an R value that is relatively uniform from the center to the edge thereof. It is, however, to be particularly appreciated and understood that unlike VIG units such as described by example in FIG. 2, an improved VIG unit system 300 such as described by example in FIG. 3 will exhibit much less decrease in localized R values around perimeters thereof.

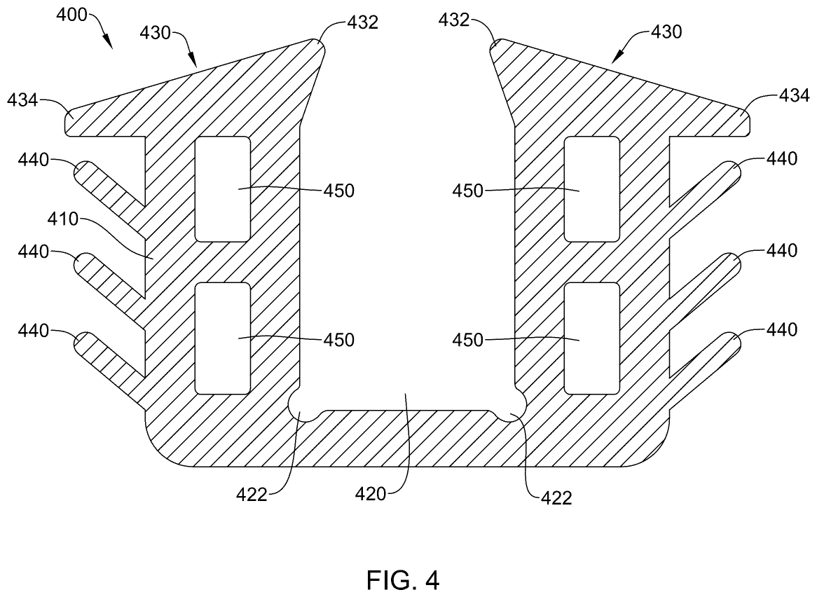

With continued reference to FIG. 3 and also now to FIG. 4, this enhancement of R value in an improved VIG unit system can be attributed to a gasket 400 that is provided at a perimeter of lites of glass 310. In an embodiment, gasket 400 can be of a relatively continuous or unsegmented construction that is disposed uninterruptedly about the perimeter of lites of glass 310. It is to be particularly appreciated and understood that gasket 400 can advantageously provide a “thermal break” between the edge of the VIG unit and the window unit frame. Specifically, a majority of the perimeter of the VIG unit can be effectively captured within gasket 400, providing additional physical separation and insulation of the VIG unit from the frame of the window system. This separation can aid in maintaining a relatively high R value (e.g., R=15.4) from the center to the edge of the VIG unit to an extent of a vision area or the “window system vision area”. In an embodiment, gasket 400 is manufactured from a suitable silicone material. Other gasket materials commonly used in the industry, such as neoprene and EPDM rubber etc., can also be effective. It is to be noted, though, that various rubber materials may contain elements of sulphur, chlorine, and/or other potentially undesirable elements. It is therefore possible that those chemistries may not be as compatible with the metal primary seal to the same extent as silicone. Also, while silicone may have a slightly higher propensity for thermal conductivity as compared to neoprene or EPDM, long-term durability of silicone can be superior to those other materials.

In the example of FIG. 4, gasket 400 can be, as depicted in cross-section, a generally U-shaped integral or unitary construction defining a gasket body 410. A central channel 420 may be defined in the gasket body 410 that is configured to accommodate secure placement therein of a VIG unit as shown, for example, in FIG. 3. The base or bottom of the channel 420 may include one or more relief regions or cutouts 422. The cutouts 422 may allow the channel 420 (e.g., the walls of the gasket body 410 that form or define the channel 422) to flex or otherwise more efficiently accommodate the VIG unit.

Adjacent to the opening of the channel 420, the gasket body 410 may include a top protrusion or head region 430. The head region 430 may have a cross-sectional shape that could be described as being generally triangular. Other shapes are contemplated. The head region 430 may include a protrusion 432 that is disposed adjacent of the opening of the channel 420. In at least some instances, the protrusion 432 may be canted radially inward or otherwise be angled toward the central axis of the opening of the channel 420. This orientation may help to form a slightly narrowed opening for the channel 420, which may be desirable for a number of reasons. For example, the orientation of the protrusion 432 may help the gasket 400 to more efficiently seal against or with the VIG unit. The head region 430 may also include a lateral or horizontal projection 434. In general, the lateral projection 434 may be deflectable, for example when installing the VIG unit and gasket 400 into a window frame, in order to help form an efficient seal between the VIG unit/gasket 400 and the window frame.

The gasket 400 may also include one or more side protrusions or fins 440. In this example, each side of the gasket 400 is shown with three side protrusions 440. Other numbers of side protrusions 440 are contemplated including one, two, three, four, five, six, seven, eight, nine, ten, or more side protrusions 440. In some instances, each side of the gasket 400 includes the same number of side protrusions 440. In other instances, the number of side protrusions 440 may vary on each side of the gasket 400. In some instances, at least some of the side protrusions 440 may be angled. For example, FIG. 4 depicts the side protrusions 440 angled generally toward the head region 430. Other orientations and/or angles are contemplated. In general, the side protrusions 440 may be deflectable, for example when installing the VIG unit and gasket 400 into a window frame, in order to help form an efficient seal between the VIG unit/gasket 400 and the window frame. The gasket 400 may also include one or more voids or openings 450 formed therein. The voids 450 may allow the gasket 400 to compress or deform when accommodating a VIG unit and/or when installing the VIG unit/gasket 400 into a window frame. It is to be appreciated and understood that when a VIG unit is installed in a frame of a window W, side protrusions 440 and voids 450, can deform from their resting states (as shown in FIG. 4) to accommodate a pressure fit or friction fit of the VIG unit in gasket 400 and, in turn, the frame of a window W (as shown in FIG. 3). It is also to be appreciated and understood that the aforementioned deformation can result in further sealing the VIG unit to the frame of the window W and thereby improve overall thermal performance of the VIG unit. Further, in an embodiment, gasket 400 can allow the VIG unit to extend lower into the frame of the window, enabling increased improved thermal performance beyond an insulating effect of material of gasket 400 residing between the VIG unit and the frame.

It is to be appreciated and understood, however, that embodiments of gasket 400 may be of varying configurations to permit for efficient glass replacement within older window units of varying dimensions, constructions, and configurations, etc. such as so-called “Champion Windows” or Champion-like window systems. Other locations, combinations, and arrangement of components are also contemplated. In an embodiment, a novel and inventive gasket—that has been described by example or otherwise contemplated herein—may have more or fewer protrusions and voids than depicted in FIGS. 3 and 4; and shapes, dimensions, and geometries of various surfaces and portions of the gasket may be changed to best accommodate a particular frame. For example, such novel and inventive gaskets can allow existing “Champion Window” systems or Champion-like window systems to be advantageously retrofitted with, for example, LandVac tVIG™ units. It is also to be appreciated and understood that embodiments of gasket 400 may also be of varying configurations to permit for efficient glass replacement within fiberglass framing systems of varying dimensions, constructions, and configurations, etc. such as so-called “fiberglass pultrusion” or “pultruded fiberglass” designs. Framing systems constructed with fiberglass pultrusion processes are often recognized as having better thermal insulating properties than aluminum framing systems. It is further to be appreciated and understood that embodiments of gasket 400 can be configurable to work in combination with VIG units and non-VIG units generally.

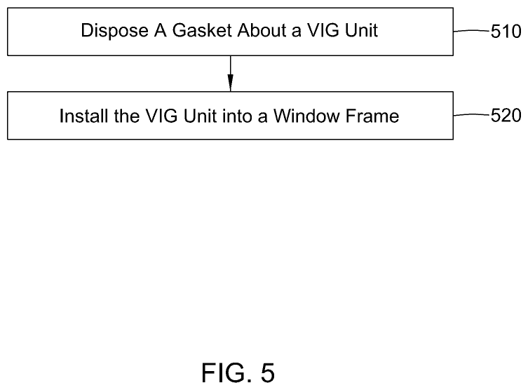

Referring now to FIG. 5, therein illustrated is a flowchart of an example of a method 500 of manufacturing an improved window system unit, including a VIG unit assembly and a gasket, in accordance with an embodiment of the disclosure. The method may include disposing a gasket (e.g., the same or similar to the gasket 400 as disclosed herein) about a VIG unit (e.g., a VIG unit, an IGU, and/or the like) at 510. The VIG unit with the gasket can be installed into a window frame at 520.

The window frame can, for example, be part of a “Champion Window” system, a Champion-like window system, or a pultruded fiberglass system, as aforementioned. The VIG unit assembly can include, also as aforedescribed, generally planar first and second lites of glass, each having a perimeter surface. At least one pillar array can be arranged between the lites of glass, for provision of generally uniform spacing between the lites of glass. A metallic sealing component, or a ceramic frit sealing component, can be provided around a perimeter of the lites of glass, with a vacuum provided therebetween by evacuating air and/or a gas from the spacing between the lites of glass. In at least some instances, the gasket may be provided adjacent to perimeter surfaces of the lite of glass. The gasket is generally positioned uniformly about the perimeter surfaces of the lites of glass.

Various embodiments of systems, devices, and methods have been described herein. These embodiments are given only by way of example and are not intended to limit the scope of the claimed subject matter. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed subject matter.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The scope of the subject matter herein is, of course, defined in the language in which the appended claims are expressed.

What is claimed is:

1. An improved window system, comprising:
a window frame;
a vacuum insulating glass unit assembly including:
a generally planar first lite of glass and a generally planar second lite of glass, each having a perimeter surface;
at least one pillar array arranged between the first lite of glass and the second lite of glass, for provision of generally uniform spacing between the first lite of glass and the second lite of glass; and
a metallic sealing component or a ceramic frit sealing component, provided around a perimeter of the first lite of glass and the second lite of glass, to enable a vacuum to be provided between the first lite of glass and the second lite of glass when a gas is evacuated from the spacing between the first lite of glass and the second lite of glass; and
a gasket provided adjacent to the perimeter surface of the first lite of glass and the perimeter surface of the second lite of glass, the gasket component being generally positioned uniformly about the perimeter surface of the first lite of glass and the perimeter surface of the second lite of glass,
wherein the vacuum insulating glass unit assembly with the gasket are configured to be installed in the window frame.

2. The improved window system of claim 1, wherein the first lite of glass and the second lite of glass each have a thickness in a range of 3.0 millimeters to 10.0 millimeters.

3. The improved window system of claim 1, wherein the spacing between the first lite of glass and the second lite of glass is in a range of 0.20 millimeters to 0.50 millimeters.

4. The improved window system of claim 1, wherein at least one of the first lite of glass and the second lite of glass is tempered or annealed.

5. The improved window system of claim 1, wherein the at least one pillar array comprises a steel construction.

6. The improved window system of claim 1, wherein the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

7. The improved window system of claim 1, wherein the gasket is generally constructed of at least one material selected from a group comprising: rubber; silicone; ethylene propylene diene monomer; ethylene propylene diene terpolymer; neoprene; and chloroprene.

8. A method of manufacturing an improved window system, the method comprising:
providing a window frame;
providing a vacuum insulating glass unit assembly including:
a generally planar first lite of glass and a generally planar second lite of glass, each having a perimeter surface;
at least one pillar array arranged between the first lite of glass and the second lite of glass, for provision of generally uniform spacing between the first lite of glass and the second lite of glass;
a metallic sealing component or a ceramic frit sealing component, provided around a perimeter of the first lite of glass and the second lite of glass; and
providing a vacuum between the first lite of glass and the second lite of glass by evacuating a gas from the spacing between the first lite of glass and the second lite of glass;
providing a gasket adjacent to the perimeter surface of the first lite of glass and the perimeter surface of the second lite of glass, the gasket component being generally positioned uniformly about the perimeter surface of the first lite of glass and the perimeter surface of the second lite of glass; and
installing the vacuum insulating glass unit assembly with the gasket in the window frame.

9. The method of claim 8, wherein the first lite of glass and the second lite of glass each have a thickness in a range of 3.0 millimeters to 10.0 millimeters.

10. The method of claim 8, wherein the spacing between the first lite of glass and the second lite of glass is in a range of 0.20 millimeters to 0.50 millimeters.

11. The method of claim 8, wherein at least one of the first lite of glass and the second lite of glass is tempered or annealed.

12. The method of claim 8, wherein the at least one pillar array comprises a steel construction.

13. The method of claim 8, wherein the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

14. The method of claim 8, wherein the gasket is generally constructed of at least one material selected from a group comprising: rubber; silicone; ethylene propylene diene monomer; ethylene propylene diene terpolymer; neoprene; and chloroprene.

15. A vacuum insulating glass unit assembly, comprising:
a generally planar first lite of glass and a generally planar second lite of glass, each having a perimeter surface;
at least one pillar array arranged between the first lite of glass and the second lite of glass, for provision of generally uniform spacing between the first lite of glass and the second lite of glass; and
a metallic sealing component or a ceramic frit sealing component, provided around a perimeter of the first lite of glass and the second lite of glass, to enable a vacuum to be provided between the first lite of glass and the second lite of glass when a gas is evacuated from the spacing between the first lite of glass and the second lite of glass; and
a gasket provided adjacent to the perimeter surface of the first lite of glass and the perimeter surface of the second lite of glass,
wherein the vacuum insulating glass unit assembly with the gasket are configured to be installed within a window frame.

16. The vacuum insulating glass unit assembly of claim 15, wherein:
the first lite of glass and the second lite of glass each have a thickness in a range of 3.0 millimeters to 10.0 millimeters;
the spacing between the first lite of glass and the second lite of glass is in a range of 0.20 millimeters to 0.50 millimeters; and/or
at least one of the first lite of glass and the second lite of glass is tempered or annealed.

17. The vacuum insulating glass unit assembly of claim 15, wherein the at least one pillar array comprises a steel construction.

18. The vacuum insulating glass unit assembly of claim 15, wherein the gasket comprises a cross-sectional U-shaped appearance having (i) an average outer width of approximately 30.00 millimeters, (ii) an average outer height of approximately 10.75 millimeters, and (iii) a central channel having an average width of approximately 9.30 millimeters.

19. The vacuum insulating glass unit assembly of claim 15, wherein the gasket is generally constructed of at least one material selected from a group comprising: rubber; silicone; ethylene propylene diene monomer; ethylene propylene diene terpolymer; neoprene; and chloroprene.

20. The vacuum insulating glass unit assembly of claim 15, wherein the gasket component is generally positioned uniformly about the perimeter surface of the first lite of glass and the perimeter surface of the second lite of glass.
